(19) United States
(12) Patent Application Publication
(10) Pub. No.: US 2015/0358543 A1
(43) Pub. Date: Dec. 10, 2015

(54) MODULAR MOTION CAPTURE SYSTEM

(71) Applicant: Ali Kord, Los Angeles, CA (US)

(72) Inventor: Ali Kord, Los Angeles, CA (US)

(21) Appl. No.: 14/731,330

(22) Filed: Jun. 4, 2015

Related U.S. Application Data
(60) Provisional application No. 62/008,394, filed on Jun. 5, 2014.

(51) Int. Cl. H04N 5/232; G06F 3/038; H04N 5/262; G06F 3/01; G06T 7/20; G06K 9/00

(52) U.S. Cl. CPC H04N 5/23258; G06T 7/2046; G06K 9/00362; H04N 5/2628; G06F 3/011; G06F 3/038; G06T 2207/30241; G06F 2203/012

(57) ABSTRACT

A motion capture apparatus includes a base unit and a motion capture accessory such as a finger IMU assembly and/or a joystick. The base unit includes an inertial measurement unit (IMU), a microprocessor in data communication with the IMU, and a plurality of IMU connectors connected to the microprocessor. The base unit further includes a communications module adapted for wired communications, a transceiver for wireless communications, and an accessory connector receptacle for mechanical connection of the motion capture accessory. The finger IMU assembly includes a housing base and a housing cap, an IMU in a void formed between the base and cap, and a flexible cable assembly electrically connected to the IMU in the finger housing assembly. The cable assembly slidably engages the housing base and includes a connector plug adapted for connection to any one of the plurality of IMU connectors on the base unit.

### CROSS REFERENCE

This application claims priority to U.S. Provisional Patent Application Ser. No. 62/008,394, filed on Jun. 5, 2014, incorporated herein by reference in its entirety.

### FIELD OF THE INVENTION

Embodiments are generally related to motion capture systems for measuring and recording positions and motions of a person's body or another moving motion capture subject.

### BACKGROUND

An articulated, movable mathematical model of a person may be created by measuring the movements of a human body while a person is performing various motions such as walking, flexing arms or legs, rotating the head, and so on. The positions of limbs and joints may be recorded and mapped onto a biomechanical skeleton that may simulate the motions of a human being. A biomechanical skeleton may be articulated differently than a human skeleton, possibly by modelling fewer joints or by aggregating some complicated structures, such as a human hand or foot, into a simpler model. For example, a foot in a biomechanical skeleton may lack toes.

Motion capture systems have used several different approaches for recording and measuring a test subject's motions and extracting parameters for a model such as a biomechanical skeleton. Some motion capture systems use triangulation to detect limb and joint positions in a camera image, for example by recording a scene with more than one camera simultaneously and comparing images captured by each camera with known camera positions, camera lens parameters, and other factors to compute skeleton parameters such as limb length, limb angle, joint position, body position, and so on. Such systems are large, possibly requiring a dedicated room, very expensive to set up, difficult to calibrate, complicated to operate, and may require sophisticated post-acquisition data analysis to process images from different cameras, each with a different view of a scene and motion capture subject. At least three motion capture targets may be placed on a subject to enable accurate measurement of positions and angles during image processing. The capture targets, for example reflective surfaces, reflective hemispheres, paint dots, and the like, may require intense illumination, cameras sensitive to infrared light, infrared light sources, or other specialized photography equipment to be effective. Capture targets may interfere with the preferred appearance or responses of the motion capture subject. Some capture targets may be blocked from the field of view of some cameras as a motion capture subject moves around, possibly impairing accurate motion capture.

Motion capture systems using multiple cameras or capture targets require accurate spatial calibration to enable accurate triangulation of target positions in camera images. Such systems may limit a person's motions to a relatively small area within a calibrated field of view of an optical system. Any changes to the positions of the motion capture cameras or capture targets may require recalibration of the entire system. Systems using acoustic rangefinders may have similar problems if an acoustic transducer is moved. Systems with pre-calibrated camera or acoustic sensor positions may be impractical for motion capture applications when the area in which a motion capture subject moves is large or must be relocated frequently or when complex lengthy calibration procedures are a disadvantage, for example when performing motion capture in a public place or a potentially dangerous environment.

Other motion capture systems require a person to wear motion sensors that are heavy enough or bulky enough to affect the motions being captured. For example, a motion sensor that is too heavy or too bulky may change the direction of a golf swing or change the velocity of a thrown ball. Some motion capture systems require a person to wear an articulated frame for measuring angles between parts of a limb, spine, torso, or other parts of a person's body. The articulated frame may be susceptible to damage during vigorous activity and may interfere with a person's speed of motion or impair a full range of motion, and may have a visual appearance that detracts from a preferred aesthetic effect in a camera image.

An electromechanical motion capture system arranged to measure positions, angles, and motions, for example an articulated frame for motion capture measurements of a person's torso, may require different data and electrical power connections than an optical system used to provide accurate information for facial expressions or finger and hand positions. Lack of interoperability between different types of motion capture systems, for example incompatible command and data formats, different attachment methods for coupling systems to a person's body, and different post-acquisition processing requirements increase the cost and complexity of motion capture and reduce the reliability of motion capture systems.

### SUMMARY

An example of an apparatus embodiment includes a base unit and a motion capture accessory such as a finger IMU assembly and/or a joystick. The base unit includes an inertial measurement unit (IMU), a microprocessor in data communication with the IMU, and a plurality of IMU connectors electrically connected to the microprocessor. The example of a base unit further includes a communications module adapted for wired communications between the microprocessor and at least one other base unit, a transceiver for wireless communications between the microprocessor and another of the base unit, and an accessory connector receptacle adapted for mechanical connection of the motion capture accessory.

The finger IMU assembly in the example of an apparatus embodiment includes a housing base and a housing cap removably attached to the housing base, an IMU disposed in a void formed between the housing base and the housing cap, and a flexible cable assembly electrically connected to the IMU in the finger housing assembly. The cable assembly slidably engages the housing base and includes a connector plug adapted for connection to any one of the plurality of IMU connectors on the base unit.

An embodiment optionally includes a motion capture accessory. The motion capture accessory includes an accessory connector plug adapted for connection to the accessory connector receptacle on the base unit. The motion capture accessory further includes a palm grip attached to the accessory connector plug.

More than one finger IMU assembly may optionally be connected to the base unit through the plurality of IMU connectors. More than one base unit may communicate with one another and with an external data processing device over a wired network connection, a wireless network connection, or both wired and wireless network connections.

### BRIEF DESCRIPTION OF THE DRAWINGS

FIG. 1 shows a pictorial view of an example of a modular motion capture system adapted to be worn on a person's left hand.

FIG. 2 shows examples of motion capture accessories mechanically disconnected from a base unit from the example of FIG. 1.

FIG. 3 shows an example of a base unit in a pictorial view toward an attachment surface for a pad for a person's right hand.

FIG. 4 shows the example of FIG. 3 in a pictorial view toward an attachment surface for a pad for a person's left hand.

FIG. 5 is a partial pictorial view of the example of a base unit from FIGS. 3-4 with part of an enclosure removed to show examples of some components positioned inside the base unit.

FIG. 6 is a pictorial view of an example of a finger inertial measurement unit (IMU) from the example of FIG. 1.

FIG. 7 shows an example of a finger IMU with a ring detached from a housing base.

FIG. 8 shows the example of a finger IMU from the previous figures with a housing cap detached from the housing base and an example of an IMU attached to the housing base in a void formed between the housing base and housing cap.

FIG. 9 shows a partial pictorial view of a finger IMU assembly from FIG. 1 with the housing cap removed to show a self-coiling cable extended to its maximum length inside the housing base.

FIG. 10 continues the example of FIG. 8 with the self-coiling cable partially retracted into the housing base.

FIG. 11 shows a pictorial view of an example of another motion capture accessory, a motion capture joystick adapted for gripping by a person's left hand.

FIG. 12 shows the example of a joystick from FIG. 11 in a viewing direction toward a trigger switch on the handgrip of the motion capture joystick.

FIG. 13 is a partial sectional view of the example of the motion capture joystick from FIGS. 11-12.

FIG. 14 is a diagram of electrical connections in an example of a base unit.

FIG. 15 is a diagram of some components included in an example of an IMU.

FIG. 16 is part of a multi-page block diagram of a networked data acquisition system embodiment.

FIG. 17 continues the block diagram of FIG. 16.

FIG. 18 continues the block diagram of FIGS. 16-17.

FIG. 19 continues the block diagram of FIGS. 16-18.

FIG. 20 continues the block diagram of FIGS. 16-19.

FIG. 21 shows an example of a networked data acquisition system including at least two base units in data communication with one another.

### DESCRIPTION

Embodiments include a rugged, compact base unit providing mechanical and electrical interfaces for a variety of sensors and transducers related to motion capture applications. A base unit in accord with an embodiment may operate as a communications node in a communications network, allowing rapid exchange of motion capture commands and data between base units and further enabling remote control of other apparatus adapted for network communications. The base unit is sufficiently small and lightweight to be worn on the back of a person's hand without impairing hand and finger motions while the person is performing as a motion capture actor for a motion picture, playing a video game, typing, or using the motion capture system as a remote control for operating other apparatus such as a vehicle, a tool, a musical instrument, sports equipment, or a remote computer system. The base unit may alternatively be worn in other locations on a person's body, for example in a headband, on an armband, against a leg, or in a pocket in a close-fitting garment. The base unit is preferably attached to a motion capture location securely enough to prevent differential motion between the base unit and the body part or object whose motion is being captured by an inertial measurement unit (IMU) in the base unit.

A base unit embodiment includes an IMU, electrical and mechanical interfaces for at least one motion capture accessory, and electrical connections for bidirectional data and command communications with other base units and optionally with an external computer system. The base unit further includes a processor module, for example a microprocessor or microcontroller implemented with semiconductor hardware devices. The processor module receives analog and/or digital signals from motion sensors for determining spatial positions, displacements, and angular motions of an object or person to which the base unit is attached. The base unit further includes inputs and outputs for audio signals, video signals, electrical power, and outputs for controlling electromechanical transducers such as rumblers, speakers, buzzers, and vibrators.

Embodiments may be calibrated rapidly and easily by performing a simple sequence of hand, finger, or body motions. Such motions may optionally be incorporated into a video game, machine control interface, or motion capture sequence and may optionally be performed without a person using an embodiment being aware that a calibration is being performed. Measurements of positions, angles, and accelerations of a motion capture subject may be used to form a mathematical model comprising a biomechanical skeleton representing positions and motions of a person's joints and appendages. Examples of a biomechanical skeleton are described in U.S. Provisional Patent Application 61/888,117, incorporated herein by reference in its entirety, and U.S. Provisional Patent Application 61/895,052, incorporated herein by reference in its entirety.

A base unit may be connected to many different types of motion capture accessories, for example a joystick for controlling a machine or a video game, a prop for a motion picture or video game, an article of sporting equipment, and so on. To accurately capture the motion of a movable accessory, the base unit and accessory are preferably coupled together firmly enough to form a rigid structure so that any differential motion between the accessory and base unit is smaller than the detection threshold of the IMU in the base unit. Examples of motion capture accessories include, but are not limited to, a simulated sword for a video game or for use as a movie prop, a tennis racket, a golf club, a baseball bat, a simulated firearm for a video game, firearms training video, or movie prop, a weapon or a simulated weapon for training of military or law enforcement personnel, a remote manipulator arm, a motion capture system using a frame connected to an arm or a leg, a stylus, a pen, a pencil, a paint brush, a glove for a hand, an article of headgear such as a helmet or hat, flight controls for an airborne vehicle, driving controls for a land vehicle, an instrument panel, a keyboard or other data entry device, a joystick, and so on. Accessories may comply with a set of electrical and/or mechanical interface specifications required for connections to a base unit, thereby providing for a common or standardized accessory interface. Some accessories may access only those electrical connections in the common accessory interface needed to operate, control or monitor the accessory. An accessory and a base unit may be adapted to automatically sense each other's input and output connections, control modes, and performance limitations.

Base units may optionally be interchangeable with one another. Interchangeable base units are easily removed from a motion capture subject and replaced in the event of unit failure. Base units may be connected together into communication networks to expand a number of IMUs and/or accessories attached to one motion capture subject, or to coordinate motion capture data collected from a motion capture subject at different times or between two or more motion capture subjects. Base units may be connected over ad hoc unit-to-unit networks or over extended networks, for example the Internet, to provide time-synchronized motion capture over large distances. A base unit may be used to measure and report positions and motions of a moving object, person, or part of a person, relative to a fixed reference position or relative to a moving reference such as another motion capture subject. A base unit may receive position and motion information from an accessory held by a person when the accessory is in data communication with the base unit.

Accessories used with a base unit may have value for entertainment, industrial control, training for hazardous environments or activities, athletic training, remote control of electromechanical manipulator arms, physical therapy, and so on. For example, a base unit coupled to a person's hand and an IMU coupled to a baseball bat could be used to teach a young player how to hit a baseball by swinging at an image of a moving ball projected into the player's field of view. Accurate sensing of finger and hand positions may be performed to implement a virtual computer keyboard or to play a virtual musical instrument, where a person interacts with a displayed object that is not physically present. A mission specialist on the ground may accurately control a manipulator arm on a spacecraft in orbit by controlling a locally displayed image of the arm with motions or positions of his or her arm, hand, and fingers captured by an embodiment. An accessory connected to the base unit may be equipped with audio, visual, or tactile feedback to provide position, acceleration, or contact information to a user wearing the base unit or to an external computer system simulating a virtual environment.

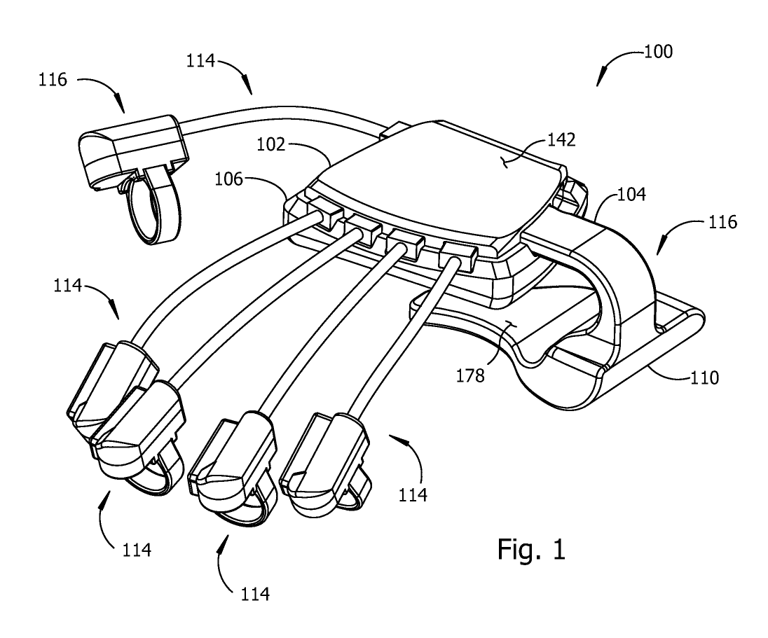

An example of a modular motion capture system 100 is shown in FIG. 1. The modular motion capture system 100 includes a base unit 102 providing electrical and mechanical connections to at least one motion capture accessory 116. The finger IMU assemblies 114 and palm grip 110 are examples of motion capture accessories 116. In the example of FIG. 1, the modular motion capture system 100 is arranged to be worn on the back side (dorsal side) of a person's left hand. A separate finger IMU assembly 114 may optionally be worn on each finger to accurately capture finger positions and motions, but any integer number of finger IMUs from 0 to 5 may be connected to the base unit depending on the needs of a particular motion capture application. The base unit 102 may be held against the dorsal side of the person's hand by the palm grip 110. The palm grip 110 connects to the base unit 102 through an accessory connector plug 104 which engages a corresponding receptacle on the base unit. The palm grip 110 includes a palm plate 178 arranged to press comfortably against the palm side of a person's hand. A pad 106 fits removably over a side of the base unit 102 to cushion the hand from contact with the base unit 102 and to prevent the base unit from slipping. The pad is preferably made from a compressible, resilient material that does not absorb moisture or odor. Alternatively, the removable pad 106 may be made from an inexpensive material that may be disposed of after use.

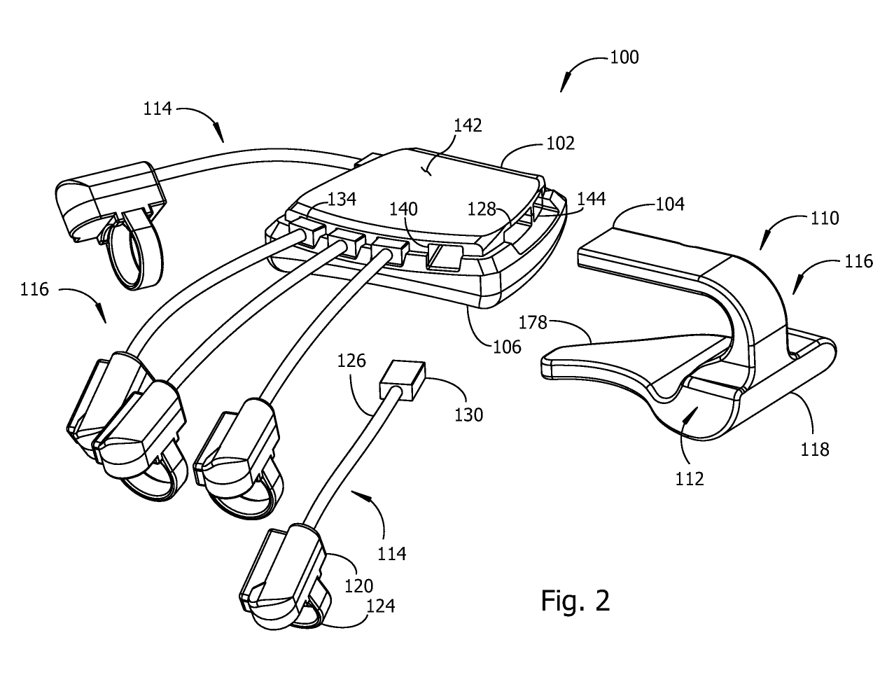

As suggested in FIG. 2, any one or more of the accessories 116 may be connected or disconnected from the base unit 102 according to the requirements of a particular motion capture application. For example, the example of a system 100 of FIGS. 1 and 2 includes seven separate accessories connected to the base unit, including four finger IMU assemblies for each of the four digits on a person's hand, another finger IMU assembly for a thumb, the palm grip 110 for holding the motion capture system against a person's hand, and the pad 106. In the example of FIG. 2, one finger IMU assembly 114 and the palm grip 110 are shown disconnected from the base unit 102, exposing an IMU connector receptacle 140, an accessory connector receptacle 128 for making a mechanical connection to an accessory connector plug 104, and an auxiliary connector receptacle 144 for making electrical connections to a corresponding electrical connector on an accessory. The palm grip 110 may further include a battery (not shown) inside a battery compartment 112 with an optional removable battery cover 118. A battery may be provided in the palm grip 110 to supply electrical power to the base unit and possibly to other accessories electrically connected to the base unit. A motion capture accessory may optionally include a battery that is not electrically connected to a base unit.

Continuing with the example of FIG. 2, a finger IMU assembly 114 is shown disconnected from its corresponding IMU connector receptacle 140. Each finger IMU assembly 114 includes a finger IMU housing 120, an optional ring 124 for a person's finger slidably engaged with the finger IMU housing 120 for holding the IMU housing on a finger, a finger IMU electrical connector plug 130 adapted for electrical and mechanical connection to a corresponding connector on the base unit 102, and a finger IMU cable assembly 126 electrically and mechanically coupling the connector plug 130 to the IMU housing 120.

The example of a modular motion capture system 100 in FIGS. 1-2 is arranged to be worn on a person's left hand. The same motion capture system 100 may be rearranged to be worn on a person's right hand by removing the pad 106 from the base unit 102, attaching another pad configured for attachment to the right hand contact surface 142, inverting the whole apparatus so the surface 142 faces toward the back side of the right hand, and detaching and reconnecting the palm grip with the palm plate 178 facing the palm of the right hand. A finger IMU assembly 114 may be worn on the fingers of either hand. The cable assemblies 126 are flexible and may be twisted along their length to accommodate wearing the rings 124 and finger IMU assemblies 114 on either the left hand or right hand.

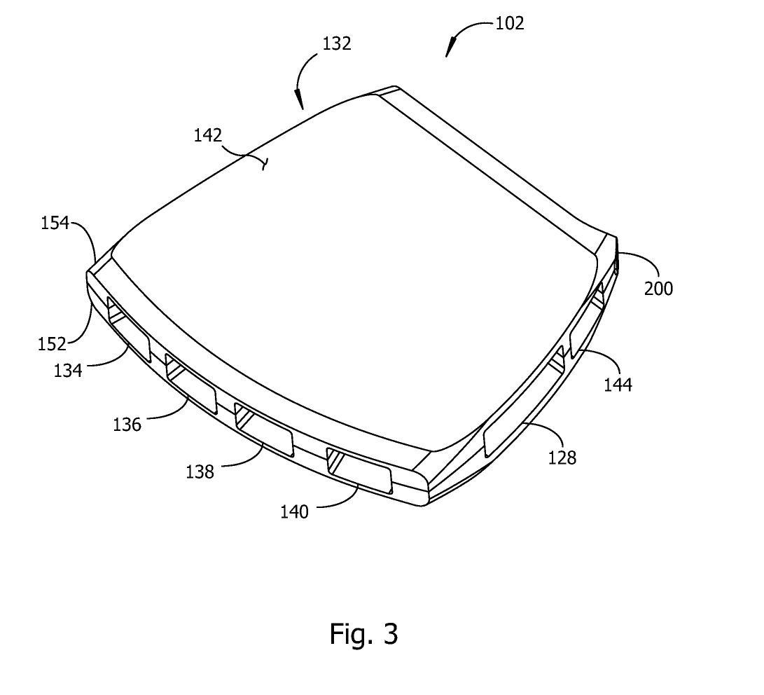

FIG. 3 shows an example of the base unit 102 in a pictorial view toward the attachment surface 142 for a right-hand pad 106. The base unit may optionally be formed as a first enclosure half 152 and a second enclosure half 154 which fit together to protect electrical components inside the base unit. The base unit includes an electrical connector receptacle 200 configured as an RS-485 communication interface. An RS-485 communication interface implements balanced multipoint network communications and may be effective for local network communications in the presence of electrical noise and radio frequency interference. An RS-485 may also be referred to as a TIA-485 interface. A socket 128 provides a secure mechanical connection to a corresponding plug on an accessory. The auxiliary connector receptacle 144 provides electrical signal connections and optionally electrical power connections between the base unit 102 and an accessory. When the base assembly 102 is used to provide motion capture for the fingers on a person's hand, a first IMU connector receptacle 132 corresponds to a thumb IMU, a second IMU connector 134 corresponds to a first or index finger IMU, a third IMU connector 136 corresponds to a second finger IMU, a fourth IMU connector 138 corresponds to a third or ring finger IMU, and a fourth IMU connector 140 corresponds to a fourth or little finger IMU. In other motion capture applications, any one or more of the five IMU connectors may be assigned to motion capture of parts of a person's body other than a finger, or to motion capture of an object. For example, an IMU connector may receive a signal from an IMU positioned at an elbow joint, a knee joint, a position along a person's spine, on a person's foot or head, a location on an accessory, and so on.

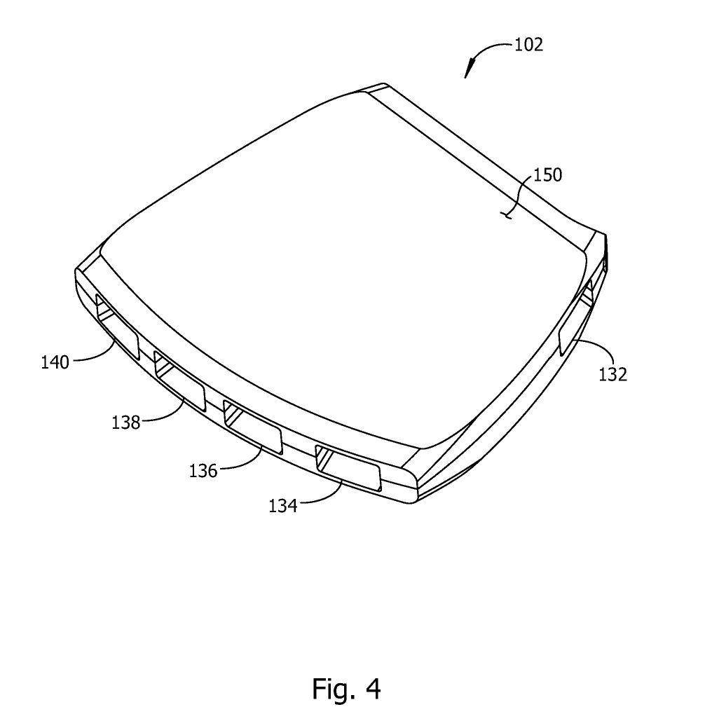

FIG. 4 shows the example of a base unit from FIG. 3 in a view toward the attachment surface 150 for a left-hand pad. When worn against a person's left hand, the surface 150 faces toward the dorsal side of the hand. When worn against a person's right hand, the surface 150 faces away from the dorsal side of the hand. Examples of the first IMU connector receptacle 132 and the other four IMU connector receptacles (134, 136, 138, 140) are also visible in FIG. 4.

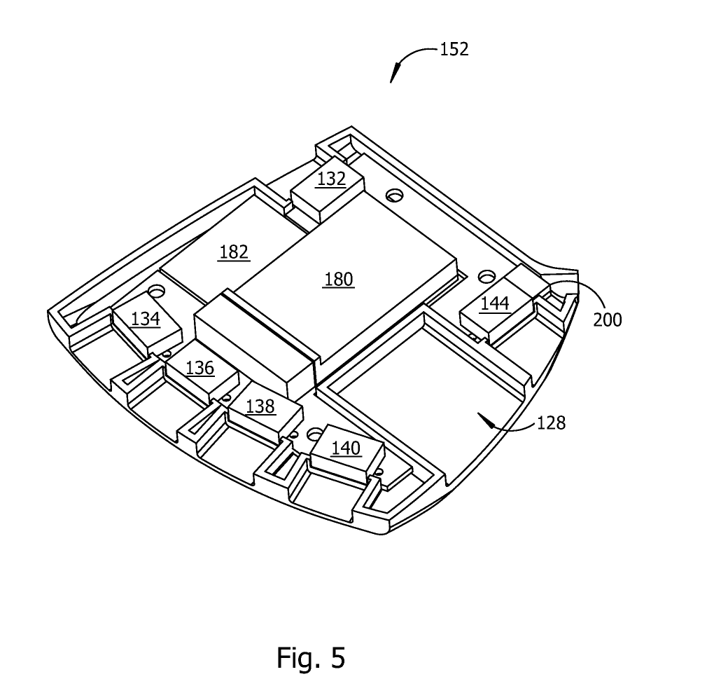

FIG. 5 illustrates an example of some of the components attached to the first enclosure half 152 of a base unit 102. Components mounted in the base unit include electrical receptacles for the first IMU connector 132, second IMU connector 134, third IMU connector 136, fourth IMU connector 138, and fifth IMU connector 140. A socket 128, also referred to as an accessory connector receptacle, functions as a mechanical receptacle for an accessory. An auxiliary electrical connector 144 provides electrical connections between an accessory and a processor module 180. In some embodiments of a base unit, the accessory connector receptacle 128 and the auxiliary electrical connector 144 may be combined into a single connector. An RS-485 connector receptacle 200 provides additional bidirectional electrical signal connections to the processor module 180. An IMU 182 electrically connected to the processor module 180 senses spatial positions, angular orientations, and accelerations relative to three mutually orthogonal spatial axes and communicates signals representative of these parameters to the processor module.

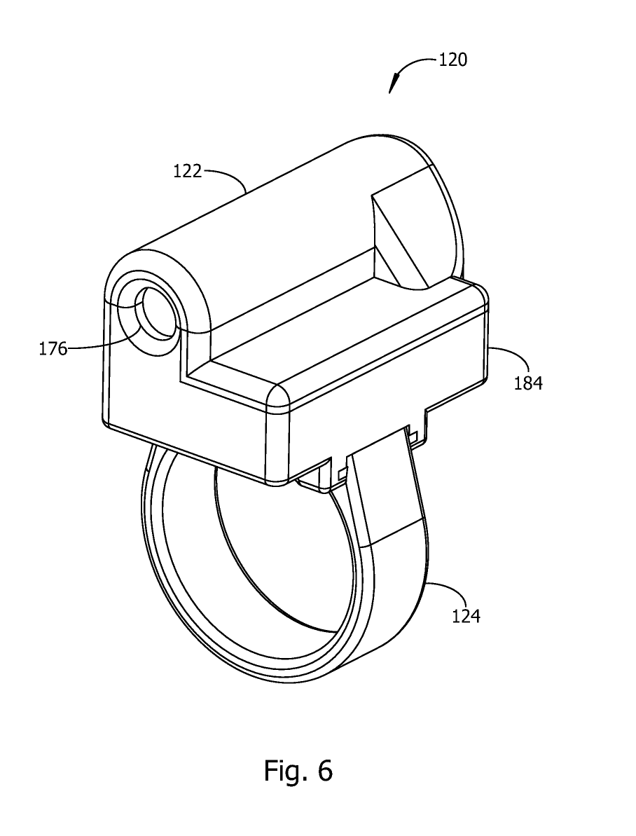

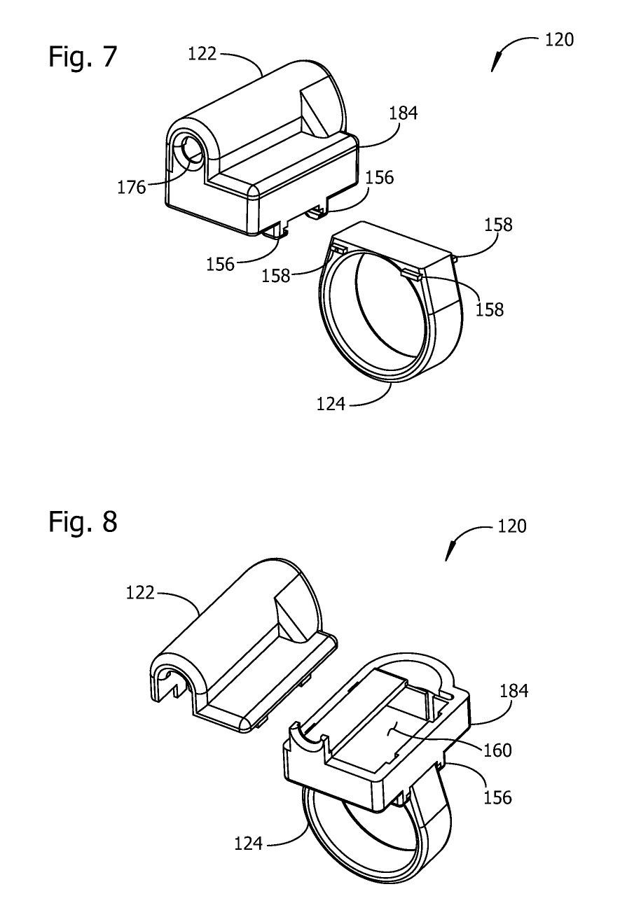

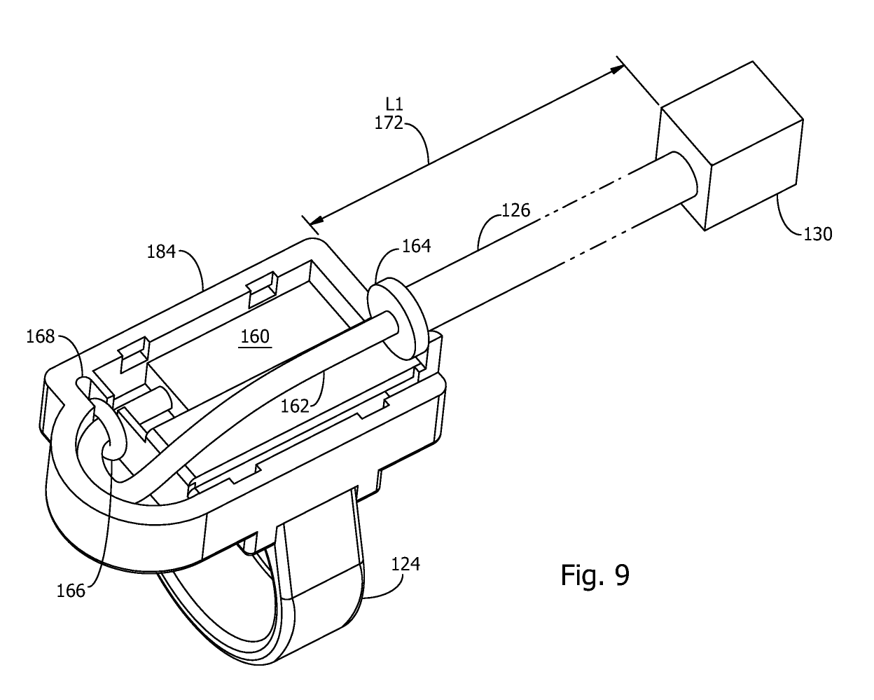

Further details of an example of a finger IMU housing 120 are shown in FIG. 6. The finger IMU housing 120 optionally includes a ring 124 sized for a sliding fit on a person's finger. The ring 124 is removable from a housing base 184 to enable rings of different diameters to be attached to the base. A housing cap 122 joined to the housing base 184 protects an IMU inside the finger IMU housing 120. An aperture 176 formed in the base, or alternately in the base and cap, is sized for a sliding fit of a finger IMU cable assembly. The ring 124 may include flanges 158 sized for a close sliding fit in corresponding brackets 156 on the housing 184, as shown in the example of FIG. 7. An IMU 160 is held within a cavity formed in the base 184 and covered by the cap 122, as in the example of FIG. 8.

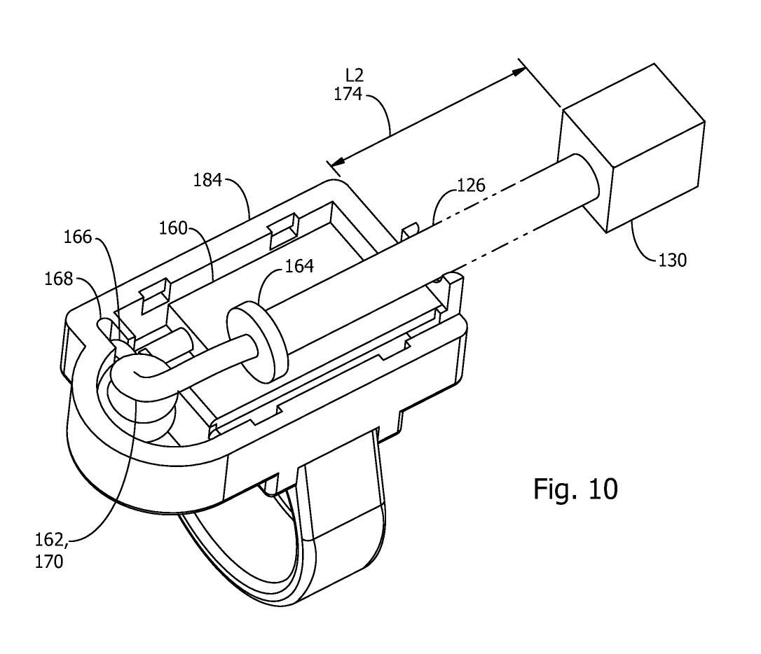

Interior features of an example of a finger IMU assembly are shown in FIGS. 9-10. In FIGS. 9-10, the cap 122 has been removed from the base 184. An IMU 160 attached to an interior surface of the base 184 measures angular and linear motions of a finger inserted through a ring 124. The IMU 160 is electrically connected to a connector plug 130 by an intervening cable assembly 126 slidably coupled to the base 184. A portion of the cable assembly 126 may be formed into a self-coiling multiconductor cable 162. A first strain relief 164 attached to the self-coiling cable 162 limits a separation distance between the base 184 and plug 130 to a maximum value L1 172, preventing the cable 162 from detaching from the base 184. A second strain relief 166 attached firmly to the self-coiling cable 162 engages a slot 168 formed in the base 184 to prevent mechanical stress on electrical connections between the self-coiling cable 162 and the IMU 160.

When tension is released from the cable assembly 126, the self-coiling multiconductor cable 162 forms a coil 170 and draws the connector plug 130 toward the base 184, as suggested in FIG. 10. The cable assembly 126 retracts into the base 184 until the cable achieves a minimum separation distance L2 174 between the base and connector plug 130. The length-adjusting feature of the cable for the finger IMU assembly adapts cable length to finger length and reduces an amount of slack cable that may interfere with a person's hand motions.

Although the examples above discuss a motion capture system suitable for wearing on a person's hand, it will be appreciated that embodiments are easily adapted to be worn on other parts of a person's body. Furthermore, a person may wear more than one base unit with the base units in data communication with one another, each base unit having an IMU inside and more IMUs optionally connected to each base unit.

A base unit may collect motion capture data that is accurately time-synchronized with other base units located a substantial distance away. For example, two or more persons separated by many miles from one another may interact in a common virtual environment when each wears a base unit outputting motion capture data synchronized to a common time reference. Furthermore, a base unit and optionally one or more IMUs may be attached to an accessory for capturing motions and positions of the accessory.

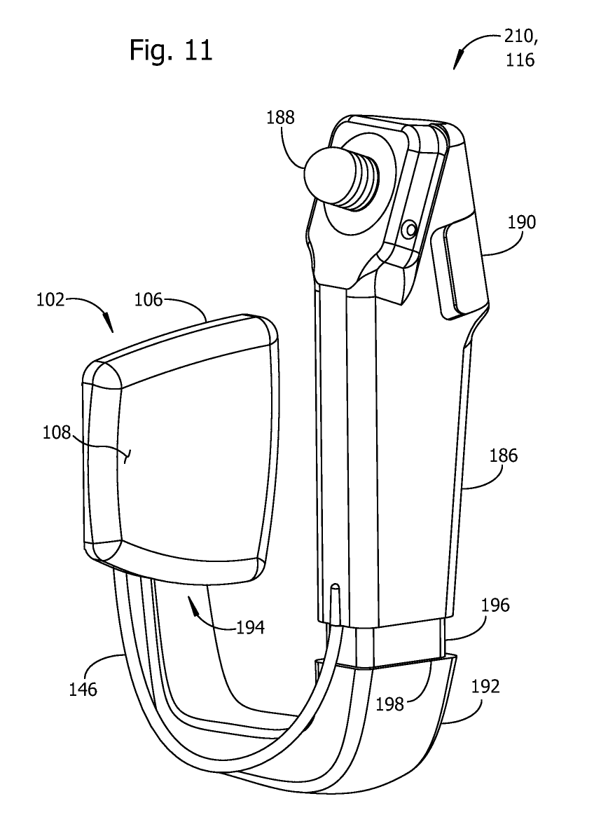

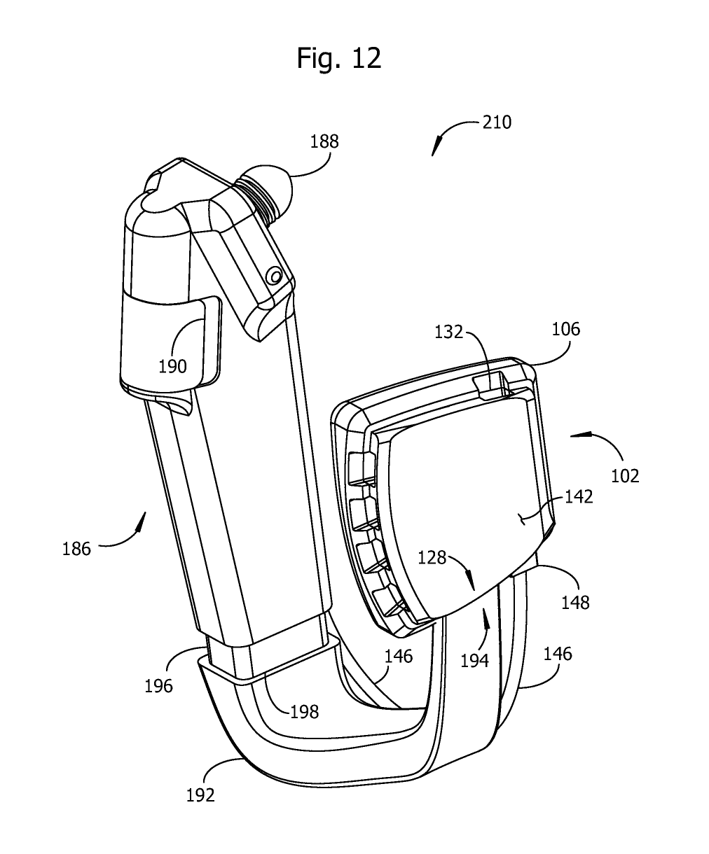

FIGS. 11-12 illustrate an example of a motion capture accessory 116 adapted for mechanical and electrical connection to a base unit 102. FIG. 11 shows an example of a motion capture joystick 210 adapted for gripping by a person's left hand. A surface 108 on the pad 106 of a base unit 102 is positioned to contact the dorsal surface of the hand, the four digits of the left hand wrapping around the hand grip 186, and the thumb positioned to deflect a tiltable joystick post 188. A measurement circuit (not illustrated) inside the handgrip 186 reports output data corresponding to deflected positions of the joystick post 188. The IMU inside the base unit (ref. FIG. 5) reports angle and position information for the entire joystick assembly 210.

FIG. 12 shows the example of a motion capture joystick 210 from FIG. 11 rotated to view the side of the hand grip 186 with a trigger switch 190 positioned for contact with an operator's index finger. A bracket 192 coupling the base unit 102 to the handgrip 186 may flex so that the pad 106 presses the person's palm against the hand grip 186, preventing the joystick from being dropped if the person releases his or her finger grip on the hand grip 186.

The hand grip 186 includes a connector plug 196 sized for a secure fit into a receptacle 198 on the bracket 192. An accessory connector plug 194 on the bracket 192 is sized for a secure fit into the accessory connector receptacle 128 on the base unit 102. An accessory electrical cable 146 with a connector plug 148 makes electrical connections between the motion capture joystick 210 and the auxiliary connector receptacle 144 on the base unit 102. The motion capture joystick of FIGS. 11-12 may be rearranged for use by a right hand by disconnecting the connector receptacle 198 from the connector plug 196, rotating the hand grip 180 degrees around its longest axis, and reconnecting the connector plug 196 to the receptacle 198 on the bracket 192 with the pad 106 positioned to contact the dorsal surface of the right hand.

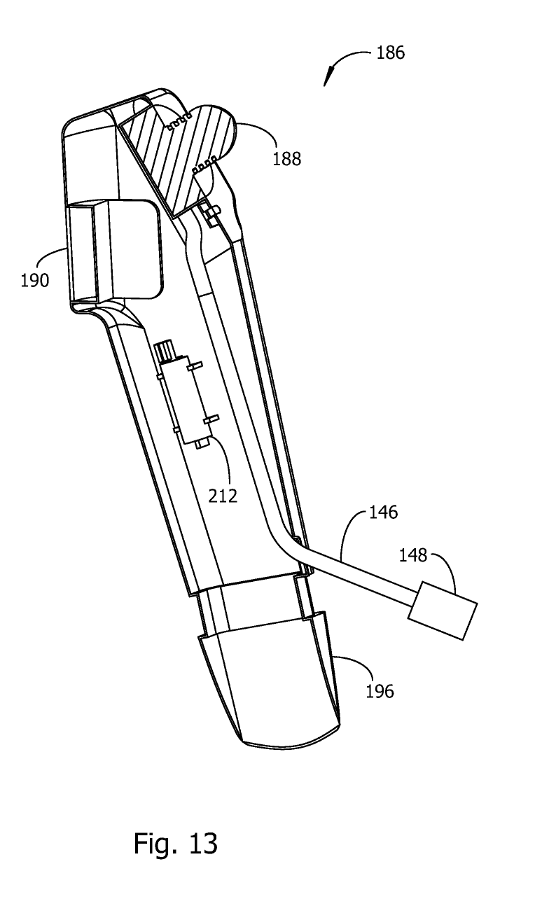

The IMU in the base unit 102 measures and reports the angular orientation and acceleration, linear position, and linear acceleration of the hand grip 186, bracket 192, and base unit relative to three mutually orthogonal spatial axes. The hand grip 186 may optionally include additional control inputs and feedback devices as suggested in the cross-sectional view of a hand grip 186 in FIG. 13. The joystick post 188 and its associated measurement circuit may be an integrated assembly available from commercial sources. An electrical cable 146 with a connector plug 148 carries electrical signals between the hand grip 186 and the receptacle 144 on the base unit 102. The optional joystick post 188 may be provided for fine control of a display cursor or for controlling part of a machine in data communication with the joystick's base unit. Position data for the joystick post 188 position data may augment or modify position and/or angle data from the IMU in the base assembly or may function as an independent control. One or more optional switches, for example a trigger switch 190, provide contact closure signals which may be detected by the control module in the base unit. The base unit may send signals for activating a vibrator, buzzer, or rumbler 212 in the hand grip 186 to provide tactile feedback to the person holding the motion capture joystick 210.

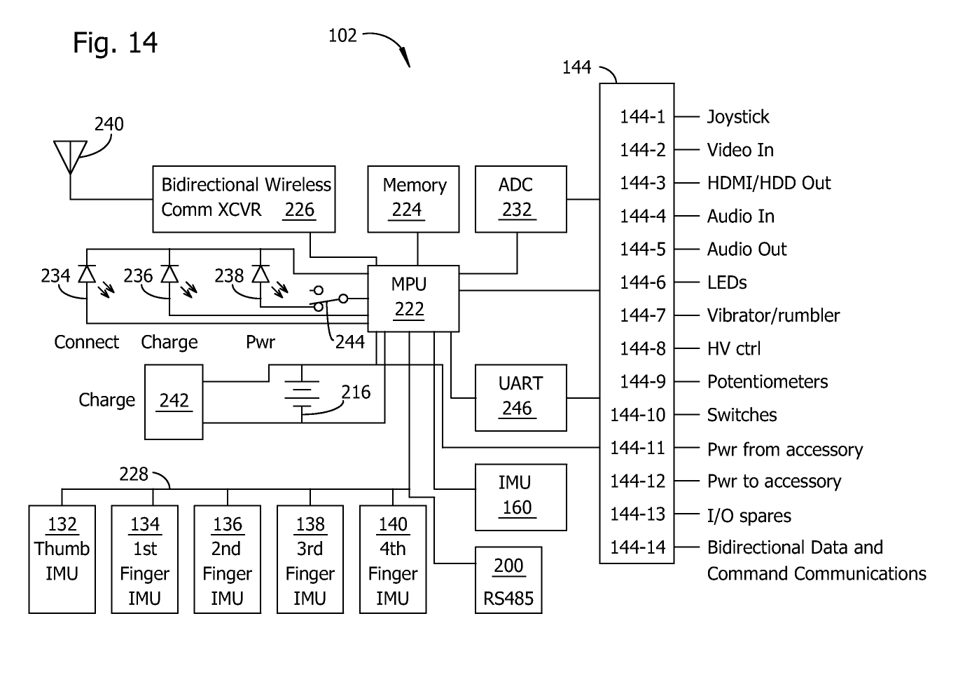

The base unit 102 may communicate acceleration, orientation, and position information to another base unit or to an external system or over a wireless connection and/or over wired connections. The base unit may optionally be adapted to activate actuators and read analog and digital signals from accessories, as shown in the block diagrams of FIGS. 14-20. A control module, represented in FIG. 14 by a microprocessor (MPU) 222, preferably a microprocessor implemented in semiconductor hardware, receives IMU data and input signals from accessories and communicates position, orientation, and acceleration information to other base units or to external computer systems or machines to be controlled. An IMU 160 may be included in the base unit 102, and the base unit may include at least one additional IMU connector receptacle 132 for receiving signals from an external IMU, for example one or more finger IMUs as shown in FIG. 1. IMU connectors (132 Thumb, 134 first finger, 136 second finger, 138 third finger, 140 fourth finger) and a sensor bus connector 200 communicate with the MPU 222 over a sensor bus 228. The sensor bus 228 preferably implements a version of TIA-485 (also referred to as RS-485).

The base unit 102 may include light emitting diodes (LEDs) or other illuminated indicators for displaying status for accessory power 238, battery charge 236, and network connections 234. An optional rechargeable battery 216 supplies power to the MPU 222 and other components connected to the base unit. A battery charge connector 242 may be provided for recharging the battery 216. Power to the base unit may be turned on and off by a switch 244. The base unit may optionally enter a low power consumption mode when the unit has been inactive for a preselected duration of time.

An analog to digital converter (ADC) 232 may be included to convert analog input signals, for example signals from a potentiometer or analog joystick in an accessory, to digital values for manipulation by the MPU 222. Semiconductor memory 224 may be provided for storing calibration data and other operating parameters, for example operating parameters and limits for accessories. The memory 224 may further serve as storage for motion capture data. Some of the memory 224 may optionally be implemented as nonvolatile memory.

The MPU 222 may exchange data and commands with other base units or with an external device through a bidirectional wireless communications transceiver 226 connected to an antenna 240. Communications may also be conducted over a communications module implementing a bidirectional wired interface, for example through a universal asynchronous receiver/transmitter (UART) 246 connected to an auxiliary connector 144. The auxiliary connector 144 includes electrical terminals for exchange of electrical signals with other parts of a motion capture system, for example, but not limited to, connections listed in the example of Table 1. Some of the electrical signals represented in Table 1 may be carried across more than one terminal in the auxiliary connector 144.

TABLE 1
Examples of I/O connections for the base unit 102

| Terminal on Auxiliary | |
|---|---|
| Connector 144 | Electrical Signal(s) Assigned to Terminal |
| 144-1 | Joystick |
| 144-2 | Video In |
| 144-3 | HDMI output to Hard Disk Drive (HDD) |
| 144-4 | Audio Input |
| 144-5 | Audio Output |
| 144-6 | LEDs |
| 144-7 | Vibrator and/or rumbler |
| 144-8 | high voltage (HV) control (ctrl) |
| 144-9 | potentiometer(s) |
| 144-10 | switch(es) |
| 144-11 | electrical power (pwr) from accessory |
| 144-12 | electrical power to accessory |
| 144-13 | I/O spare terminal(s) |
| 144-14 | bidirectional data and command |
| | communication signals |

The MPU 222 may retrieve image display information from memory 224 or from another device in data communication with the base unit for displaying video or computer graphics on an external display device such as a computer monitor, heads-up display, or virtual reality goggles. The MPU 222 may be adapted to control a high voltage (HV) circuit in an accessory, for example to deliver a mild electric shock to a person holding the accessory, for turning on and off visual or audio annunciators in an accessory, and for activating or deactivating an accessory.

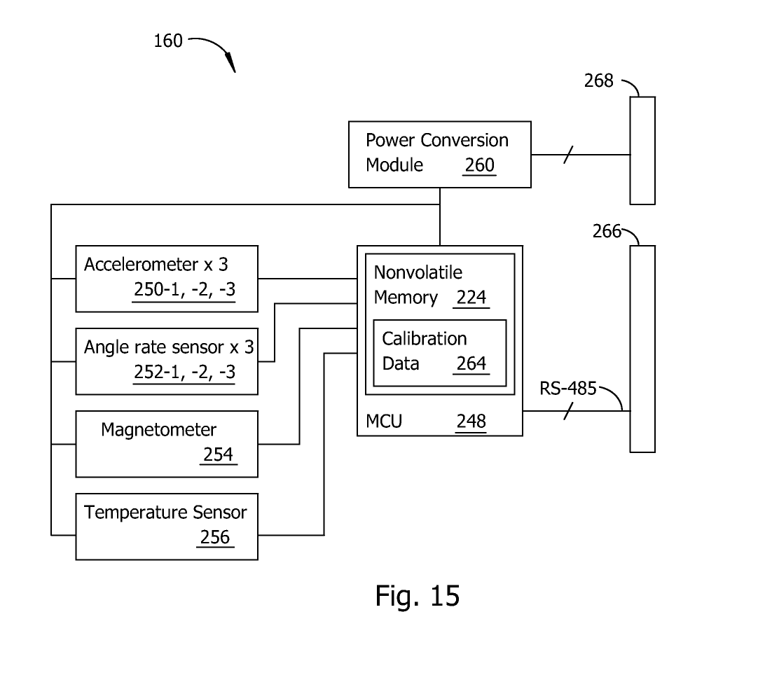

An IMU suitable for use with an embodiment preferably measures angular and linear motion and position relative to three mutually perpendicular spatial axes. An example of an IMU 160 is shown in FIG. 15. Separate angle rate sensors 252-1, 252-2, and 252-3 and separate accelerometers 250-1, 250-2, and 250-3 may optionally be provided for each of the three independent spatial axes. An IMU capable of measuring angular motion and linear motion for each of three separate spatial axes may be referred to as having six degrees of freedom. An IMU 160 may further include a local processor MCU 248 and nonvolatile memory 224 for retaining calibration data 264, and may include a temperature sensor 256, a magnetometer 254, and circuits for vibration and shock compensation. A power conversion module 260 converts current and voltage provided at an electrical connector 268 to values used by circuits within the IMU 160. An IMU may further include a UART for sending position and acceleration information to the processor module in the base unit and for receiving commands from the processor module in the base unit over an RS-485 interface 266. As an example, an IMU 160 included in a finger IMU housing used with some embodiments has dimensions of approximately 12 mm×10 mm×4 mm.

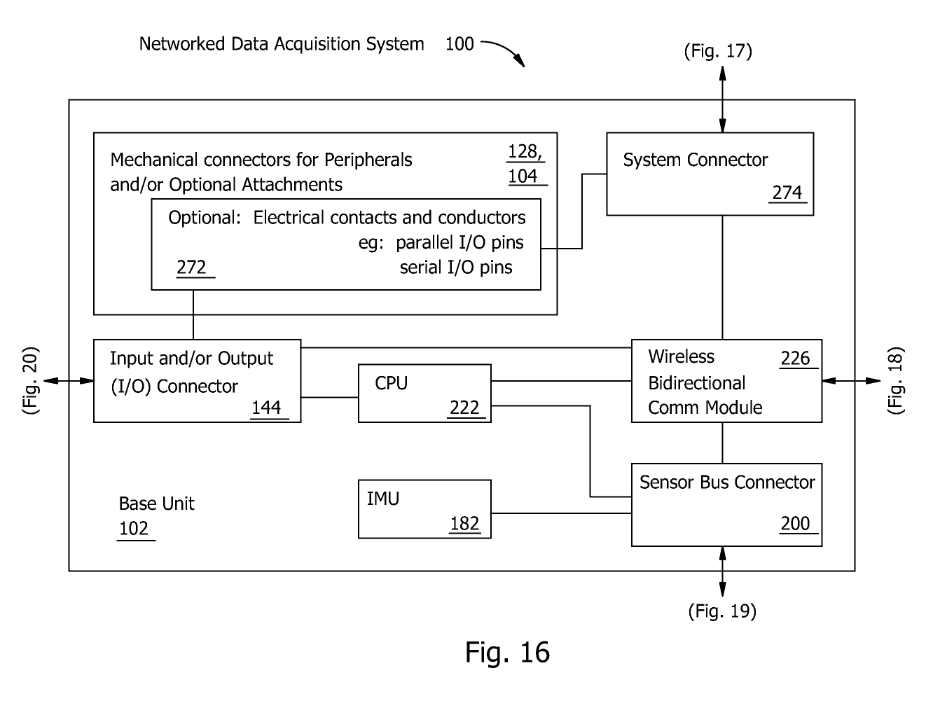

A base unit may be a member of a networked data acquisition system, exchanging data and commands with other base units and possibly with external devices such as desktop computers, tablet computers, laptop computers, smart phones, game consoles, and other communications-enabled data processing devices. An example of an embodiment 100 comprising a networked data acquisition system is shown in the extended block diagram of FIGS. 16-20. The base unit 102 is a communications node in the larger networked data acquisition system 100.

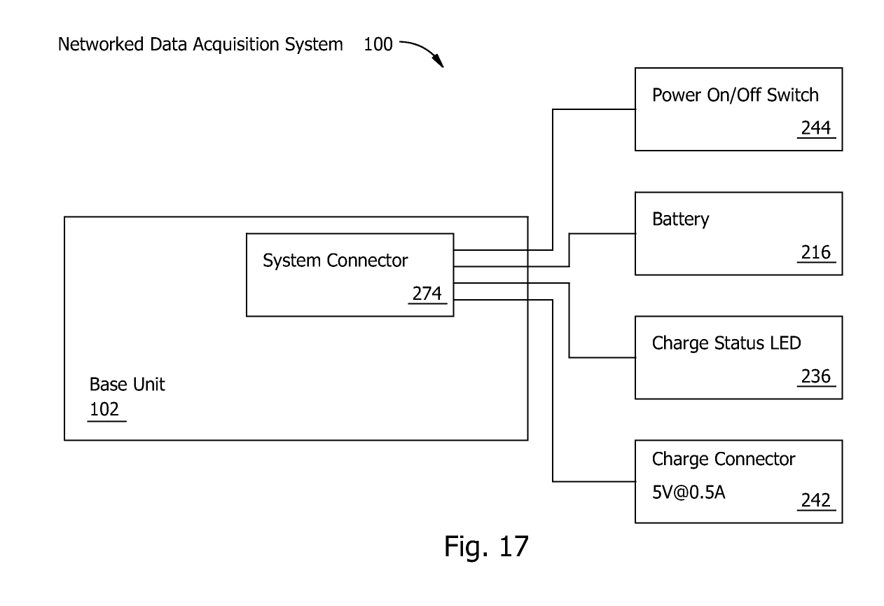

Parts of FIG. 16 have already been described in earlier figures. The base unit 102 may further include a system connector 274 electrically connected to optional electrical contacts 272 in an accessory connector receptacle 128 and plug 104. The system connector 274 consolidates frequently-accessed electrical signals into a connector convenient for testing, troubleshooting, interfacing motion capture accessories, and programming the CPU 222. For example, in FIG. 17 the System Connector 274 is electrically connected to the Power on/Off switch 244, an optional battery 216 for providing electrical power to the base unit and optionally to accessories, a charge status LED 236 which may be illuminated to indicate the battery is sufficiently charged to operate the base unit, and a charge connector 274 for connecting the battery and other parts of the base unit to an external power source, for example a battery charger capable of producing 5 volts at 0.5 amps, or other voltages and currents as required by the battery, base unit, and accessories.

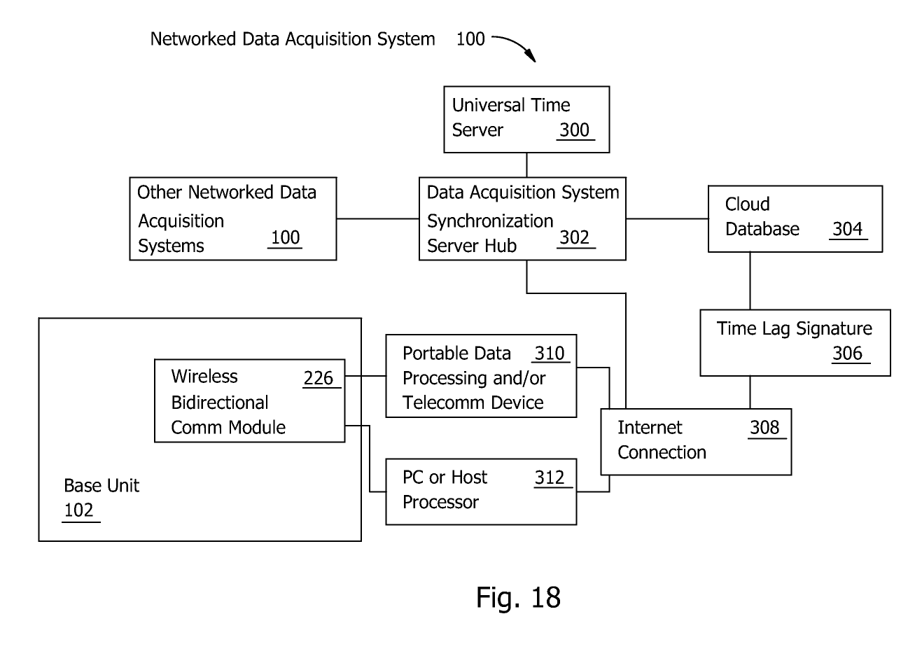

The wireless bidirectional communications module 226 from FIG. 16 may establish wireless communications with other devices as suggested in FIG. 18. The base unit 102 may optionally exchange data and commands with a portable data processing and/or telecommunications device 310 and with a personal computer or host processor 312. Any one or more of the data processing and/or telecommunications devices, personal computer, or host processor may provide a communications link to the internet 308. A data acquisition system synchronization server hub 302, a computer system implemented in hardware and configured as a network server, may be accessible to the base unit 102 over the internet connection 308. Data from one or more base units 102 may be stored in a cloud database 304 accessible to authorized devices over the internet connection 308. The server hub 302 may optionally time-stamp each motion capture data record from a base unit with time data provided by a universal time server 300 to provide time-synchronized motion capture across multiple motion capture system embodiments separated from one another by substantial distances. The universal time server 300 may optionally provide a uniform time reference to all motion capture systems connected to the network. A time lag signature 306 may be associated with each communication path to a base unit to permit time-synchronized motion capture data to be compensated for communication delays. Compensated time-synchronized motion capture data and parameters may optionally be stored in a database 304 accessible to network-connected devices. Other networked data acquisition systems 100 may communicated with a selected base unit 102 through the server hub 302 and internet connection 308.

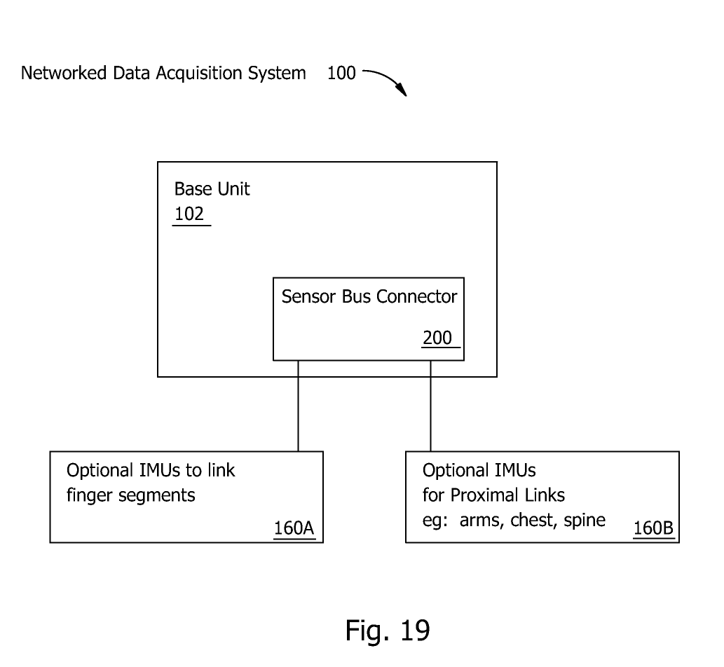

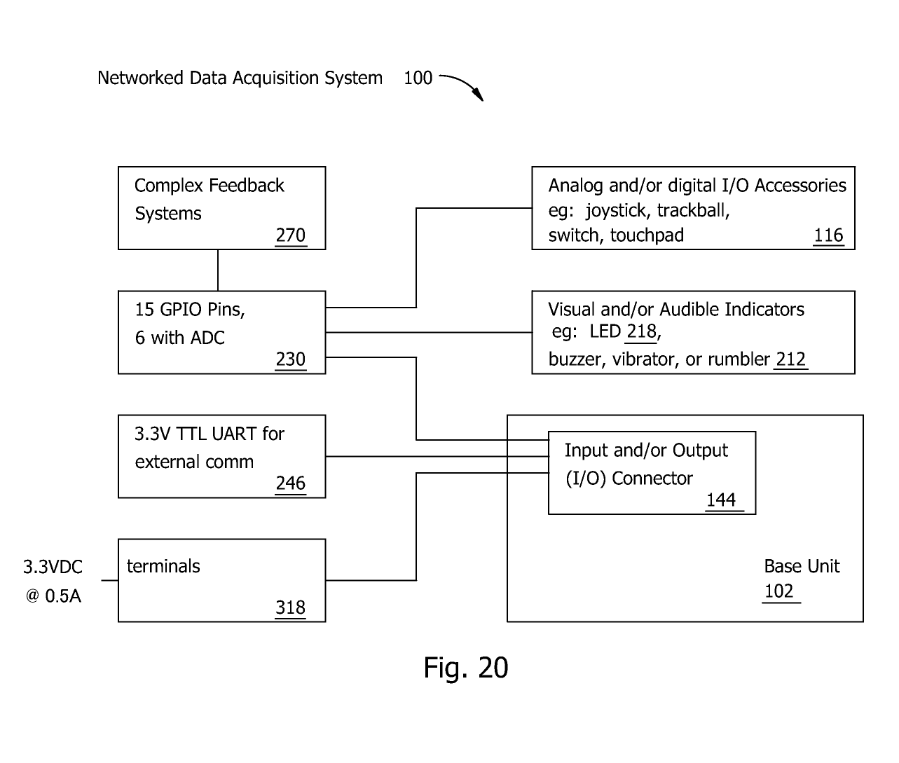

Other features of a base unit in a networked data acquisition system are shown in FIGS. 19-20. In FIG. 19, the sensor bus connector 200 in the base unit 102 may receive electrical signals from IMUs 160A for linking finger segments in a biomechanical model. Other optional IMUs 160B may communicate motion capture signals for locations on the arms, chest, or spine of a motion capture subject. As suggested in FIG. 20, a base unit 102 may further include GPIO pins 230 available for interfacing accessories. For example, six of the pins may optionally be accessible to the ADC 232 in the base unit. GPIO pins 230 may further be used for driving indicators such as an LED 218, a vibrator, buzzer, or rumbler 212, or other indicators. The base unit may further include terminals 318 for providing electrical power to accessories, optional parallel input and output (I/O) pins 272 for interfacing to accessories, and complex feedback systems 270. System connections 274 are provided for the power switch 244, a battery 216, for example a LiPol rechargeable battery, charge status indicator LED 236, and a charge connector 242.

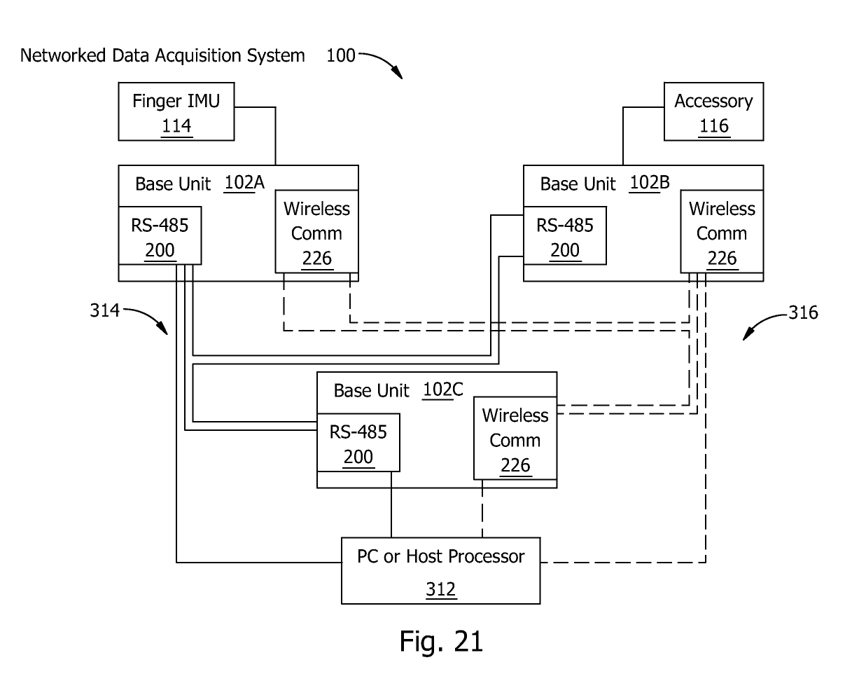

FIG. 21 shows an example of a networked data acquisition system 100 in accord with an embodiment. A first base unit 102A may optionally be connected for data communications to a second base unit 102B. Data communications may occur over wired connections 314, wireless connections 316, or a combination of wired and wireless connections. Data from a motion capture accessory connected to the first base unit 102, for example a finger IMU 114, and another motion capture accessory 116 connected to the second base unit 102B may be communicated directly by each base unit to a personal computer (PC) or host processor 312. Alternatively, any designated base unit, for example a third base unit 102C, may serve as a communications intermediary between other base units and the host processor. The designated base unit may optionally operate as a data consolidator for other base units, and may further operate as a wireless range extender for any base unit too far removed from the host processor for direct wireless communication. All of the base units may be positioned on a same motion capture subject, or may alternately be positioned on different motion capture subjects.

Unless expressly stated otherwise herein, ordinary terms have their corresponding ordinary meanings within the respective contexts of their presentations, and ordinary terms of art have their corresponding regular meanings.

What is claimed is:

1. A motion capture apparatus, comprising:
a base unit comprising:
an inertial measurement unit (IMU);
a microprocessor in data communication with said IMU;
a plurality of IMU connectors electrically connected to said microprocessor;
a communications module adapted for wired communications between said microprocessor and another of said base unit;
a transceiver for wireless communications between said microprocessor and another of said base unit; and
an accessory connector receptacle adapted for mechanical connection of a motion capture accessory; and
a finger IMU assembly, comprising:
a housing base and a housing cap removably attached to said housing base;
an IMU; and
a cable assembly electrically connected to said IMU, said cable assembly including a connector plug adapted for connection to any one of said plurality of IMU connectors, wherein said cable assembly slidably engages said housing base.

2. The motion capture apparatus of claim 1, further comprising a motion capture accessory comprising:
an accessory connector plug adapted for connection to said accessory connector receptacle; and
a palm grip attached to said accessory connector plug.

3. The motion capture apparatus of claim 1, further comprising a second of said finger IMU assembly coupled to said base unit.

4. The motion capture apparatus of claim 1, wherein said base unit comprises four of said IMU connectors on a first side of said base unit and one of said IMU connectors on a second side of said base unit adjacent said first side.

5. The motion capture apparatus of claim 4, wherein said second side of said base unit is a side opposite said accessory connector.

6. The motion capture apparatus of claim 1, wherein said plurality of IMU connectors on said base unit are in data communication with said microprocessor over a sensor bus implementing a version of TIA-485.

7. The motion capture apparatus of claim 1, wherein said finger IMU assembly further comprises a first strain relief attached to said cable assembly, said first strain relief disposed to prevent said cable assembly from detaching from said housing base.

8. The motion capture apparatus of claim 7, wherein said finger IMU assembly further comprises a second strain relief attached to said cable assembly near said IMU in said finger IMU assembly, said second strain relief engaging a slot formed in said housing base.

9. The motion capture apparatus of claim 1, further comprising an analog-to-digital converter connected for data communication with said microprocessor.

10. The motion capture apparatus of claim 1, wherein said communications module adapted for wired communications includes a universal asynchronous receiver-transmitter (UART).

11. The motion capture apparatus of claim 1, wherein said base unit comprises a first base unit, and further comprising a second of said base unit in data communication with said first base unit.

12. The motion capture apparatus of claim 11, wherein said second base unit consolidates motion capture data from said first and second base units.

13. The motion capture apparatus of claim 11, wherein said second base unit extends a wireless communication range for said first base unit.

14. The motion capture apparatus of claim 1, wherein said base unit further comprises a battery for providing electrical power to said microprocessor, a light-emitting diode for indicating a charge status of said battery, and a charging connector for coupling electrical power to said battery.

15. The motion capture apparatus of claim 1, further comprising a ring for a person's finger slidably engaged with said housing base.

16. The motion capture apparatus of claim 1, further comprising a joystick coupled to said base unit.

17. The motion capture apparatus of claim 16, wherein said joystick includes a bracket having an accessory connector plug adapted for connection to said accessory connector receptacle.

18. The motion capture apparatus of claim 16, wherein said joystick further comprises:
a handgrip, said bracket extending from an end of said handgrip;
a joystick post tiltably coupled to said handgrip; and
an electrical cable terminated in an electrical connector compatible for coupling to said accessory connector on said base unit.

19. The motion capture apparatus of claim 18, further comprising a rumbler mounted inside said handgrip.

20. The motion capture apparatus of claim 18, further comprising a trigger switch coupled to said handgrip.
